(19) United States
(12) Patent Application Publication
(10) Pub. No.: US 2011/0200201 A1
(43) Pub. Date: Aug. 18, 2011

(54) MEASUREMENT SIGNAL GENERATING DEVICE, MEASUREMENT SIGNAL GENERATING METHOD, MEASUREMENT SIGNAL GENERATING PROGRAM AND STORAGE MEDIUM

(75) Inventor: Hiroyuki Ishihara, Kanagawa (JP)

(73) Assignee: PIONEER CORPORATION, Kanagawa (JP)

(21) Appl. No.: 13/124,049

(22) PCT Filed: Oct. 16, 2008
(86) PCT No.: PCT/JP2008/068737

§ 371 Date: Apr. 13, 2011

(51) Int. Cl. H04R 29/00

(52) U.S. Cl. 381/58

(57) ABSTRACT

A measurement signal generating device is suitably applied to an AV system capable of generating measurement signals used for a sound field correction. Concretely, based on an average value and a standard deviation of a correlation value between two channels in plural channels, a measurement signal generating unit determines an amount for mixing the two signals between the two channels. Then, the measurement signal generating unit generates the measurement signal by mixing the two signals based on the determined amount for mixing the two signals, so as to generate the measurement signals for the plural channels. Thereby, it is possible to generate the measurement signals having the correlation between the channels which is close to a real content. Therefore, by performing the sound field correction by using the measurement signals, it becomes possible to reduce a gap with an evaluation at the time of reproducing the real content.

### TECHNICAL FIELD

The present invention relates to a technical field for generating a measurement signal used for a surround correction of an AV system.

### BACKGROUND TECHNIQUE

Recently, an AV system formed by plural speakers such as 5.1 channels is used. Generally, as for the AV system, a specific signal such as a noise is used for a measurement signal for a surround correction (for example, sound field correction). For example, the measurement signal in which all of plural channels are the same phase and the same level is used. The measurement signal is not a signal in which a relationship (concretely, correlation) between channels of a real content is considered. Therefore, a gap between an evaluation by using the measurement signal and an evaluation of the real content tends to occur. Namely, by the conventional technology, it is difficult to evaluate a characteristic when the plural channels are synthesized.

There are disclosed techniques related to the present invention in Patent References 1 and 2.

Patent Reference-1 : Japanese Patent Application Laid-open under No. 07-319483

Patent Reference-2 : Japanese Patent Application Laid-open under No. 2005/523624

### DISCLOSURE OF INVENTION

### Problem to be Solved by the Invention

The present invention has been achieved in order to solve the above problem. It is an object of the present invention to provide a measurement signal generating device, a measurement signal generating method, a measurement signal generating program and a storage medium, which can appropriately generate measurement signals for plural channels in consideration of a correlation between channels.

### Means for Solving the Problem

In the invention according to claim 1, a measurement signal generating device which generates measurement signals for plural channels includes a measurement signal generating unit which determines an amount for mixing two signals between two channels based on an average value and a standard deviation of a correlation value between the two channels in the plural channels, and generates a measurement signal by mixing the two signals based on the amount for mixing the two signals, so as to generate the measurement signals for the plural channels.

In the invention according to claim 9, a measurement signal generating method which generates measurement signals for plural channels includes a measurement signal generating process which determines an amount for mixing two signals between two channels based on an average value and a standard deviation of a correlation value between the two channels in the plural channels, and generates a measurement signal by mixing the two signals based on the amount for mixing the two signals, so as to generate the measurement signals for the plural channels.

In the invention according to claim 10, a measurement signal generating program executed by a computer, which generates measurement signals for plural channels, making the computer function as a measurement signal generating unit which determines an amount for mixing two signals between two channels based on an average value and a standard deviation of a correlation value between the two channels in the plural channels, and generates a measurement signal by mixing the two signals based on the amount for mixing the two signals, so as to generate the measurement signals for the plural channels.

In the invention according to claim 11, in a storage medium storing measurement signals for plural channels, the measurement signals for the plural channels differ in a correlation value between two channels in the plural channels.

### BRIEF DESCRIPTION OF THE DRAWINGS

FIG. 1 shows a schematic diagram showing a configuration of an AV system to which a measurement signal generating device according to an embodiment is applied.

FIG. 2 is a diagram showing processing units of a sound field measurement processing unit.

FIGS. 3A and 3B are diagrams showing configuration examples and arrangement examples of a speaker.

FIGS. 4A to 4F show examples of sound pressure distributions adjacent to listening points.

FIGS. 5A and 5B are diagrams for explaining a correlation between channels of a real content.

FIG. 6 is a diagram for explaining a method for simulating a correlation between channels.

FIG. 7 is a diagram showing a concrete example of processing units of a measurement signal generating unit.

FIG. 8 is a diagram for explaining a method for determining a mixing amount.

FIGS. 9A and 9B are diagrams for explaining a concrete example of a mixing processing method.

FIGS. 10A and 10B are diagrams showing examples of a correlation value between channels of generated measurement signals.

FIG. 11 is a diagram showing an example of a correlation value between channels of a real content.

FIG. 12 is a flow chart showing a measurement signal generating process according to an embodiment.

### BRIEF DESCRIPTION OF THE REFERENCE NUMBER

12 User Interface

13 Microphone

14 Sound Field Correction Processing Unit

15 Sound Field Measurement Processing Unit

16 Control Unit

18 Speaker

51 Measurement Signal Generating Unit

51a Uncorrelated Signal Generating Unit

51f Correlated Signal Generating Unit

51g Random Number Generation Processing Unit

51h Mixing Amount Determination Processing Unit

51i Mixing Processing Unit

51k Memory Unit

100 AV System

### DETAILED DESCRIPTION OF THE PREFERRED EMBODIMENTS

According to one aspect of the present invention, there is provided a measurement signal generating device which generates measurement signals for plural channels, including a measurement signal generating unit which determines an amount for mixing two signals between two channels based on an average value and a standard deviation of a correlation value between the two channels in the plural channels, and generates a measurement signal by mixing the two signals based on the amount for mixing the two signals, so as to generate the measurement signals for the plural channels.

The above measurement signal generating device is suitably applied to an AV system capable of generating the measurement signals used for a sound field correction, and generates the measurement signals for the plural channels. Concretely, based on the average value and the standard deviation of the correlation value between the two channels in the plural channels, the measurement signal generating unit determines the amount for mixing the two signals between the two channels. Then, the measurement signal generating unit generates the measurement signal by mixing the two signals based on the determined amount for mixing the two signals, so as to generate the measurement signals for the plural channels. Thereby, it is possible to generate the measurement signals having the correlation between the channels which is close to the real content. Therefore, by performing the sound field correction by using the measurement signals, it becomes possible to reduce the gap with an evaluation at the time of reproducing the real content. Namely, by the above measurement signal generating device, it is possible to appropriately evaluate a characteristic when the plural channels are synthesized.

In a manner of the above measurement signal generating device, the measurement signal generating unit can generate the measurement signals for the plural channels by simulating a correlation between the two channels of a content based on the average value and the standard deviation of the correlation value between the two channels in the plural channels.

In another manner of the above measurement signal generating device, the measurement signal generating unit selects adjacent channels as the two channels in the plural channels.

In this manner, since the adjacent channels tend to show a relatively strong correlation, the measurement signal generating unit generates the measurement signals in consideration of the correlation. Therefore, it becomes possible to generate the measurement signals having the correlation between the channels which is closer to the real content.

In a preferred example of the above measurement signal generating device, the measurement signal generating unit includes a random number generating unit which generates random number data of the correlation value having a variation in a time direction, in accordance with the average value and the standard deviation of the correlation value between the two channels, based on a normal distribution random number generating algorithm.

Further, preferably, the measurement signal generating unit includes a mixing amount determining unit which determines the amount for mixing the two signals between the two channels, based on the random number data generated by the random number generating unit. For example, based on a relationship between the correlation value and the amount for the mixing (mixing amount) which is preliminarily calculated, the mixing amount determining unit determines the mixing amount corresponding to the random number data generated by the random number generating unit.

Further, preferably, the measurement signal generating unit includes a mixing processing unit which performs a process of mixing uncorrelated signals between arbitrary two channels in uncorrelated signals generated for the plural channels, or mixing the uncorrelated signal generated for the plural channels and the measurement signal, by the mixing amount determined by the mixing amount determining unit.

In a preferred example, the average value and the standard deviation of the correlation value are set based on at least either one of a genre of music and a melody of music. Therefore, since the correlation value between the channels varies by the genre of music and the melody of music, it becomes possible to generate the measurement signals in accordance with the tendency.

Further, in a preferred example, the above measurement signal generating device further includes a storage unit which stores the measurement signals generated by the measurement signal generating unit.

According to another aspect of the present invention, there is provided a measurement signal generating method which generates measurement signals for plural channels, including a measurement signal generating process which determines an amount for mixing two signals between two channels based on an average value and a standard deviation of a correlation value between the two channels in the plural channels, and generates a measurement signal by mixing the two signals based on the amount for mixing the two signals, so as to generate the measurement signals for the plural channels.

According to still another aspect of the present invention, there is provided a measurement signal generating program executed by a computer, which generates measurement signals for plural channels, making the computer function as a measurement signal generating unit which determines an amount for mixing two signals between two channels based on an average value and a standard deviation of a correlation value between the two channels in the plural channels, and generates a measurement signal by mixing the two signals based on the amount for mixing the two signals, so as to generate the measurement signals for the plural channels.

According to still another aspect of the present invention, there is provided a storage medium storing measurement signals for plural channels. In the above storage medium, the measurement signals for the plural channels differ in a correlation value between two channels in the plural channels.

In a preferred example of the above storage medium, the measurement signals for the plural channels are generated by a measurement signal generated by mixing two signals based on an amount for mixing the two signals between two channels, and the amount for mixing the two signals is determined based on an average value and a standard deviation of a correlation value between the two channels in the plural channels.

By the measurement signal generating method, the measurement signal generating program and the storage medium, it is possible to generate the measurement signals having the correlation between the channels which is close to the real content, too. Therefore, by performing the sound field correction by using the measurement signals, it becomes possible to reduce the gap with the evaluation at the time of reproducing the real content.

### EMBODIMENT

A preferred embodiment of the present invention will be explained hereinafter with reference to the drawings.

[System Configuration]

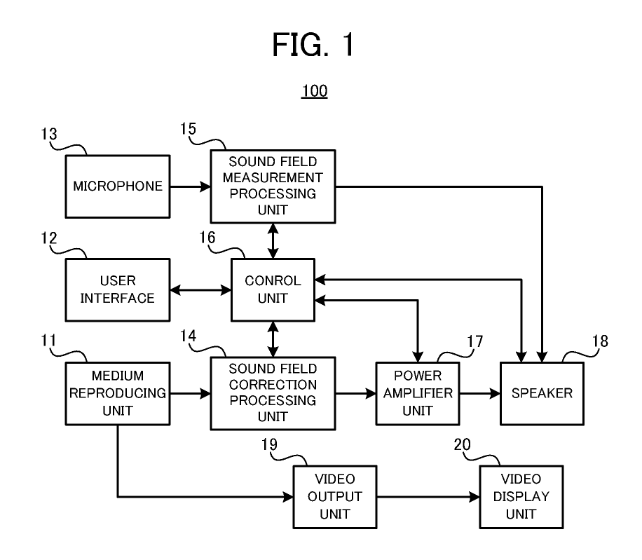

FIG. 1 shows a schematic diagram showing a configuration of an AV system 100 to which a measurement signal generating device according to an embodiment is applied.

The AV system 100 mainly includes a medium reproducing unit 11, a user interface 12, a microphone 13, a sound field correction processing unit 14, a sound field measurement processing unit 15, a control unit 16, a power amplifier unit 17, a speaker 18, a video output unit 19 and a video display unit 20.

By reproducing CD (Compact Disc), DVD (Digital Versatile Disc) and BD (Blu-ray Disc) , the medium reproducing unit 11 provides a sound signal to the sound field correction processing unit 14, and provides a video signal to the video output unit 19. The user interface 12 is formed so that a user can perform a variety of operation, and provides the control unit 16 with a signal corresponding to the operation by the user. The microphone 13 collects a sound and provides a sound signal to the sound field measurement processing unit 15. For example, the microphone 13 collects the sound output by the speaker 18.

The sound field correction processing unit 14 is controlled by the control unit 16, and performs a correction of the sound signal provided by the medium reproducing unit 11, in accordance with a measurement result of a sound field. For example, the sound field correction processing unit 14 performs a frequency correction, a level correction and a time correction from the speaker 18 to a listening point. The power amplifier unit 17 performs a process of amplifying the sound signal provided by the sound field correction processing unit 14, and provides the speaker 18 with the sound signal after the process.

The sound field measurement processing unit 15 performs a process of measuring a sound field from the speaker 18 to the listeningpoint, based on the sound signal obtained by the microphone 13. Specifically, the sound field measurement processing unit 15 generates a measurement signal (test signal) used for a sound field correction so as to make the speaker 18 output the measurement signal, and performs the process of measuring the sound field based on the measurement signal collected by the microphone 13. The speaker 18 includes plural speakers (for example, five speakers) , and outputs the sound signal processed by the power amplifier unit 17 or the measurement signal generated by the sound field measurement processing unit 15. The control unit 16 switches the sound signal output by the speaker 18.

The control unit 16 inputs and outputs the signal with the user interface 12, the sound field correction processing unit 14, the sound field measurement processing unit 15, the power amplifier unit 17 and the speaker 18, and performs a variety of controls. The control unit 16 mainly inputs and outputs the signal with the sound field measurement processing unit 15 and the sound field correction processing unit 14, and performs a control of generating the measurement signal and a control of the sound field correction.

The video output unit 19 performs a predetermined process of a video signal reproduced by the medium reproducing unit 11, and provides the output video signal to the video display unit 20. The video display unit 20 performs a process of displaying the video signal output by the video output unit 19.

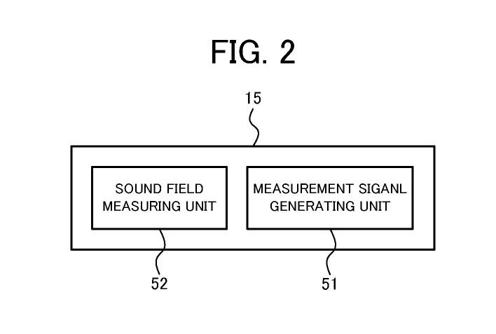

FIG. 2 is a diagram showing processing units of the sound field measurement processing unit 15. The sound field measurement processing unit 15 includes a measurement signal generating unit 51 which generates the measurement signal for the sound field measurement, and a sound field measuring unit 52 which measures the sound field based on the measurement signal. Concretely, the measurement signal generating unit 51 generates measurement signals for plural channels, and makes the speaker 18 output the generated measurement signals. The sound field measuring unit 52 measures the sound field based on the measurement signals output by the speaker 18. Specifically, the sound field measuring unit 52 measures the sound field based on the measurement signals collected by the microphone 13. The measurement signal generating unit 51 corresponds to the measurement signal generating device in the present invention, and functions as the measurement signal generating unit.

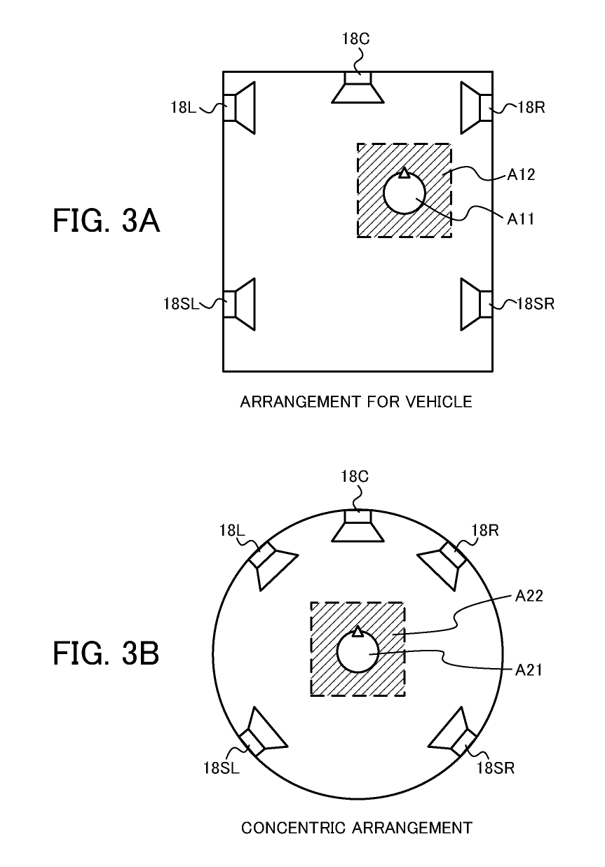

FIGS. 3A and 3B are diagrams showing configuration examples and arrangement examples of the speaker 18. Here, such an example that the speaker 18 includes five speakers will be given. Concretely, as shown in FIGS. 3A and 3B, the speaker 18 includes a speaker 18C arranged at the center, a speaker 18R arranged at the right front, a speaker 18L arranged at the left front, a speaker 18SR arranged at the right rear and a speaker 18SL arranged at the left rear.

FIG. 3A shows a diagram when the speaker 18 is arranged for a vehicle (the speaker 18 is arranged in a vehicle interior) . In this case, the listening point is located at a position shown by a reference numeral All, for example. Additionally, a hatching area A12 shows an example of a sound pressure distribution adjacent to the listening point All. Meanwhile, FIG. 3B shows a diagram when the speaker 18 is arranged concentrically. In this case, the listening point is located at a position shown by a reference numeral A21, for example. Additionally, a hatching area A22 shows an example of a sound pressure distribution adjacent to the listening point A21.

[Measurement Signal Generating Method]

Next, a concrete description will be given of a measurement signal generating method in the embodiment. In the embodiment, the measurement signal generating unit 51 appropriately takes into consideration a correlation between the channels, and performs the process of generating the measurement signals for the plural channels (for example, five channels) . Concretely, based on an average value and a standard deviation of a correlation value between two channels in the plural channels, the measurement signal generating unit 51 determines an amount for mixing the two signals between the two channels, and generates the measurement signal by mixing the two signals based on the amount for mixing the two signals, so as to generate the measurement signals for the plural channels. Namely, based on the average value and the standard deviation of the correlation value between the two channels in the plural channels, the measurement signal generating unit 51 generates the measurement signals for the plural channels by simulating a correlation between the two channels of a real content.

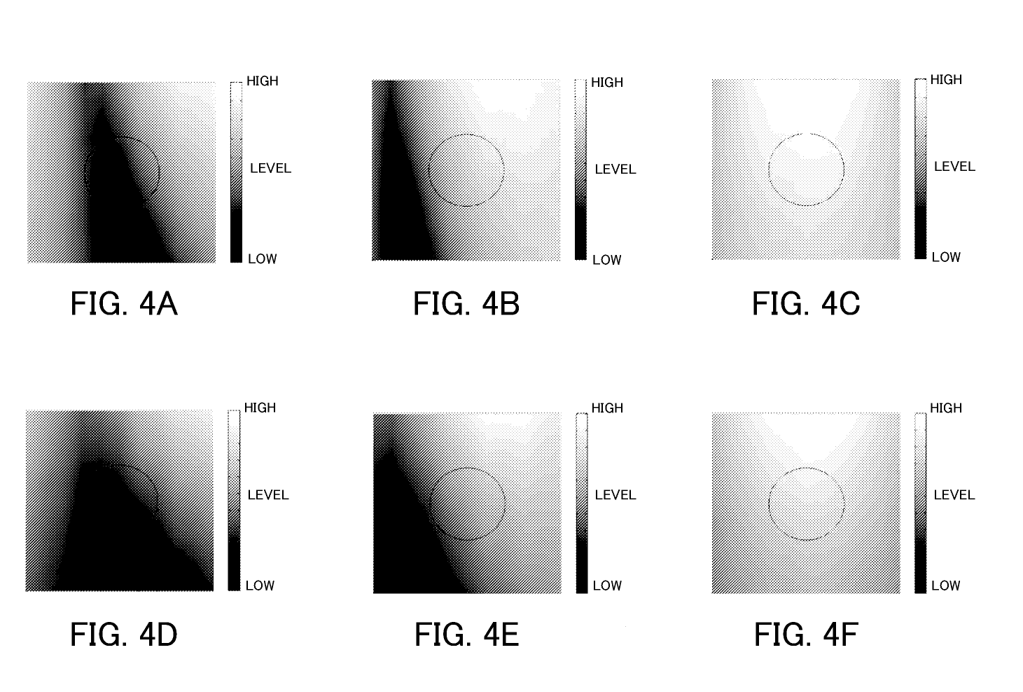

Here, a description will be given of a reason for performing the above measurement signal generating method, with reference to FIGS. 4A to 4F, FIGS. 5A and 5B and FIG. 6.

FIGS. 4A to 4F show examples of the sound pressure distributions (corresponding to the hatching areas A12 and A22) adjacent to the listening points All and A21 when the speaker 18 is arranged as shown in FIGS. 3A and 3B. FIGS. 4A to 4F show the sound pressure distributions when only the speakers 18R and 18L arranged at the front output the sound signal. Additionally, in FIGS. 4A to 4F, circles shown by a solid line correspond to an immediate neighborhood of the listening point, and a sound pressure level becomes higher as a color shown by a grayscale becomes lighter .

FIGS . 4A to 4C show examples of sound pressure distributions when the speakers 18R and 18L output the same phase signal. Concretely, FIG. 4A shows a sound pressure distribution at the listening point All when the speaker 18 is arranged for the vehicle . As for the sound pressure distribution, the sound field correction (such as time correction) is not performed. As shown in FIG. 4A, it can be understood that a center of the sound pressure significantly deviates. FIG. 4B shows a sound pressure distribution in such a case that the time correction (time alignment correction) of a signal obtained at the listening point All is performed when the speaker 18 is arranged for the vehicle. As shown in FIG. 4B, it can be understood that a deviation of the center of the sound pressure decreased compared with the sound pressure distribution shown in FIG. 4A. Meanwhile, FIG. 4C shows a sound pressure distribution at the listening point A21 when the speaker 18 is arranged concentrically. As shown in FIG. 4C, it can be understood that the sound pressure distribution is a homogeneous distribution and is an ideal distribution.

Next, FIGS. 4D to 4F show examples of sound pressure distributions when the speakers 18R and 18L output the sound signal of the real content. Concretely, FIG. 4D shows a sound pressure distribution at the listening point All when the speaker 18 is arranged for the vehicle. As for the sound pressure distribution, the sound field correction is not performed. As shown in FIG. 4D, it can be understood that the center of the sound pressure significantly deviates. FIG. 4E shows a sound pressure distribution in such a case that the time correction of a signal obtained at the listening point All is performed when the speaker 18 is arranged for the vehicle. As shown in FIG. 4E, it can be understood that the center of the sound pressure deviates compared with the sound pressure distribution shown in FIG. 4B. Namely, it can be understood that a gap between an evaluation by using the measurement signals (same phase signals) and an evaluation of the real content occurs. Therefore, as for the real content, it can be said that it is not enough to perform the time correction alone. Meanwhile, FIG. 4F shows a sound pressure distribution at the listening point A21 when the speaker 18 is arranged concentrically. As shown in FIG. 4F, it can be understood that the sound pressure distribution is the homogeneous distribution and is the ideal distribution.

Thus, when the real content is reproduced, it is preferable that the sound field correction is performed so that the sound pressure distribution as shown in FIGS. 4C and 4F is obtained, regardless of the speaker arrangement and the listening point. Concretely, in addition to the above time correction, it is preferable that a correction in accordance with a level difference between the speakers 18R and 18L is performed. Therefore, in the embodiment, the measurement signals are generated so that the gap with the evaluation at the time of reproducing the real content is filled. Namely, the measurement signals for the plural channels are generated in consideration of the correlation between the channels so that the gap with the evaluation at the time of reproducing the real content reduces , and the sound field correction is performed based on the measurement signals.

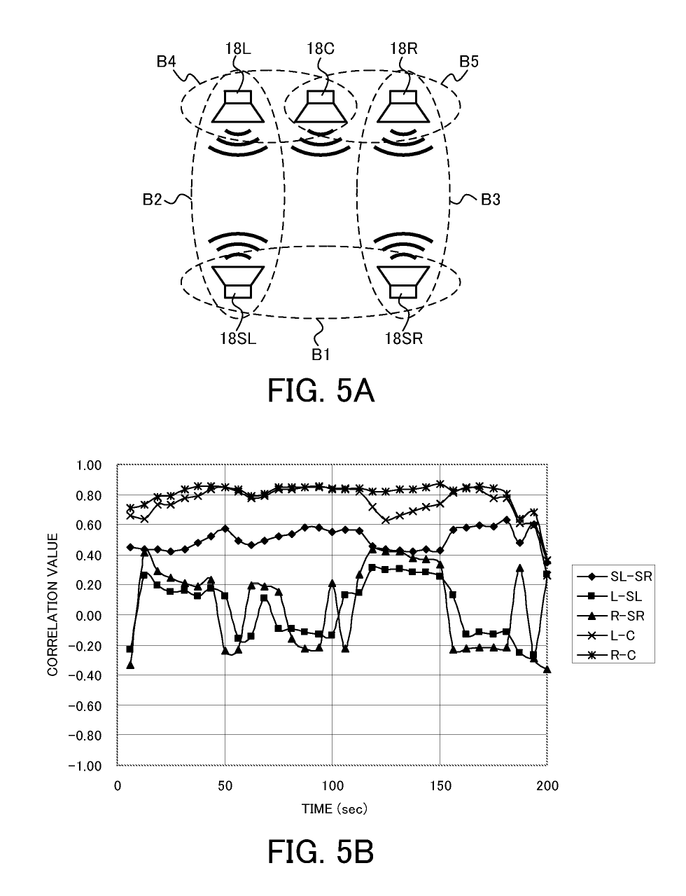

FIGS. 5A and 5B are diagrams for explaining a correlation between channels of the real content. Here, such an example of correlation values between adjacent channels when the five speakers 18C, 18R, 18L, 18SR and 18SL are arranged as shown in FIG. 5A will be given. Concretely, a description will be given of a correlation value between the channels of the speakers 18SR and 18SL shown by a broken line B1, a correlation value between the channels of the speakers 18L and 18SL shown by a broken line B2, a correlation value between the channels of the speakers 18R and 18SR shown by a broken line B3, a correlation value between the channels of the speakers 18C and 18L shown by a broken line B4 and a correlation value between the channels of the speakers 18C and 18R shown by a broken line B5.

In FIG. 5B, a horizontal axis shows time (sec), and a vertical axis shows a correlation value. Concretely, FIG. 5B shows examples of a time variation of the correlation value between the above channels of the real content. As shown in FIG. 5B, it can be understood that the average value of the correlation value differs between the channels. Additionally, it can be understood that the correlation value temporally varies (namely, the correlation value varies in a direction of a time axis) and a behavior of the time variation differs between the channels. In the embodiment, in consideration of the average value and the time variation of the correlation value between the channels of the real content, the measurement signals in which the average value and the time variation are simulated are generated.

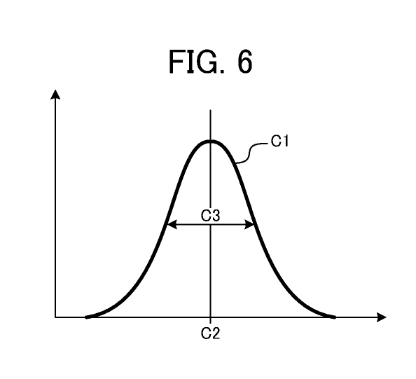

FIG. 6 is a diagram for explaining a method for simulating the correlation between the channels. In the embodiment, the correlation between the channels is simulated by using a normal distribution shown by a curved line C1, so as to generate the measurement signals for the plural channels. Concretely, the average value of the correlation value is simulated by an average value C2 of the normal distribution C1, and the time variation of the correlation value is simulated by a standard deviation C3 of the normal distribution C1.

By the above measurement signal generating method, it is possible to generate the measurement signals having the correlation between the channels which is close to the real content . Therefore, by performing the sound field correction by using the measurement signals, it becomes possible to reduce the gap with the evaluation at the time of reproducing the real content. Namely, by the measurement signal generating method according to the embodiment, it becomes possible to appropriately evaluate a characteristic when the plural channels are synthesized.

[Example Of Measurement Signal Generating Unit]

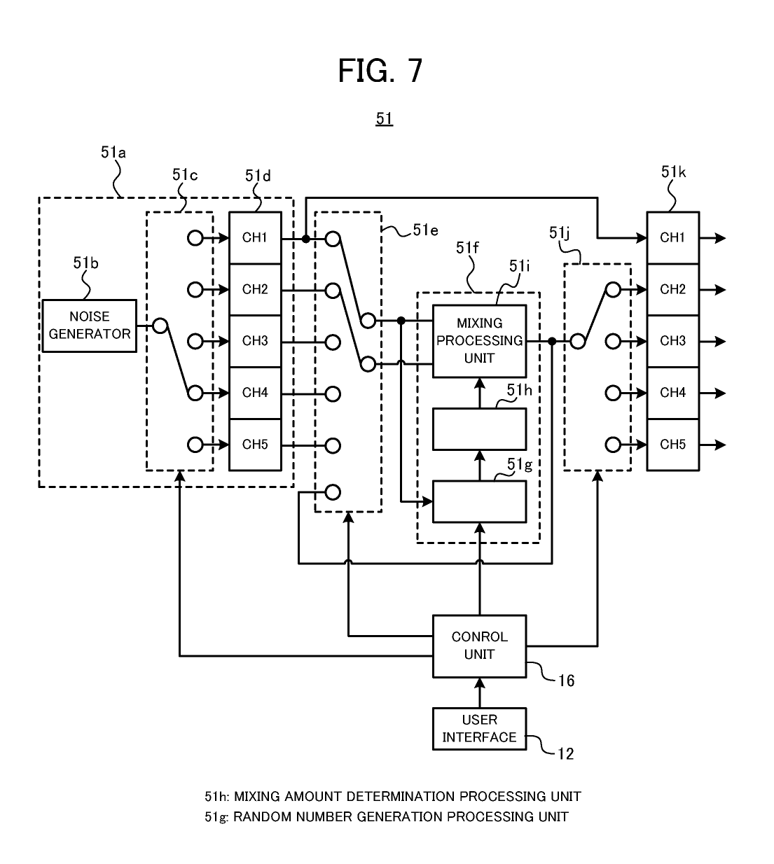

Next, a description will be given of a configuration example of the measurement signal generating unit 51 which can realize the above measurement signal generating method, with reference to FIG. 7.

FIG. 7 is a diagram showing processing units of the measurement signal generating unit 51. As shown in FIG. 7, the measurement signal generating unit 51 mainly includes an uncorrelated signal generating unit 51a, a correlated signal generating unit 51f and a memory unit 51k.

The measurement signal generating unit 51 performs a process of generating uncorrelated signals for five channels (CH1 to CH5). Concretely, the measurement signal generating unit 51 includes a noise generator 51b which generates an uncorrelated signal such as a pink noise and/or a white noise, a switch unit 51c which can switch a supply destination of the uncorrelated signal generated by the noise generator 51b and a memory unit 51d which stores the uncorrelated signals for the five channels. A switch unit 51e selects the uncorrelated signals for the two channels in the uncorrelated signals for the five channels stored in the memory unit 51d, in accordance with a command from the control unit 16, and provides the correlated signal generating unit 51f with the uncorrelated signals for the two channels.

The correlated signal generating unit 51f performs a process of generating the measurement signals (correlated signals) , in accordance with the correlation between the two channels selected by the switch unit 51e. Concretely, the correlated signal generating unit 51f includes a random number generation processing unit 51g, a mixing amount determination processing unit 51h and a mixing processing unit 51i. The random number generation processing unit 51g obtains the average value and the standard deviation of the correlation value between the two channels selected by the switch unit 51e, from the control unit 16. Then, based on a normal distribution random number generating algorithm, the random number generation processing unit 51g generates random number data of the correlation value (hereinafter suitably referred to as “correlation value information”) having a variation in a time direction, in accordance with the average value and the standard deviation of the correlation value. Namely, the random number generation processing unit 51g controls the variation of the correlation value of the signals between the selected two channels.

In details, in addition to the average value and the standard deviation of the correlation value between the two channels, the random number generation processing unit 51g obtains a time length of the measurement signals to generate and the number of division for dividing the measurement signals having the time length by a predetermined time unit (hereinafter, the unit of the divided signal is referred to as “divided frame”), from the control unit 16. Then, based on the normal distribution random number generating algorithm, the random number generation processing unit 51g generates the random number data (±1) for the number of the divided frames in accordance with the obtained average value and standard deviation of the correlation value. Thereafter, the random number generation processing unit 51g provides the mixing amount determination processing unit 51h with the generated random number data as the correlation value information. The random number generation processing unit 51g generates the correlation value information for every two channels in the plural channels (for example, between CH1 and CH2, between CH2 and CH3, and between CH3 and CH4) . Thus, the random number generation processing unit 51g functions as the random number generating unit in the present invention.

The average value and the standard deviation of the correlation value obtained by the random number generation processing unit 51g are set for every two channels in the plural channels, in accordance with a genre of music (such as classical music, rock music and jazz music) and/or a melody of music and/or an image (such as cheerful feeling and comfortable feeling) of the sound field to generate, for example . In this case, the user selects at least any one of the genre of music, the melody of music and the image of the sound field, and the control unit 16 determines the average value and the standard deviation of the correlation value in accordance with the selection and provides the average value and the standard deviation to the random number generation processing unit 51g. For example, the average value and the standard deviation of the correlation value for every two channels in the plural channels are stored in association with the genre of music, the melody of music and the image of the sound field.

Next, the mixing amount determination processing unit 51h performs a process of converting the correlation value information obtained by the random number generation processing unit 51g into the mixing amount. The mixing amount corresponds to the amount (in other words, mixing proportion) for mixing the two signals between the two channels selected by the switch unit 51e. Since the random number data for the number of the divided frames exists, the mixing amount is calculated for the number of the divided frames and is calculated for every two channels in the plural channels. Specifically, the mixing amount corresponds to the amount for mixing the uncorrelated signal or the measurement signal (already generated signal) of one channel and the uncorrelated signal of the other. For example, based on a relationship (such as map) between the correlation value and the mixing amount which is preliminarily calculated by an experiment, the mixing amount determination processing unit 51h determines the mixing amount corresponding to the obtained correlation value information. Then, the mixing amount determination processing unit 51h provides the mixing processing unit 51i with the determined mixing amount. Thus, the mixing amount determination processing unit 51h functions as the mixing amount determining unit.

By using the mixing amount determined by the mixing amount determination processing unit 51h, the mixing processing unit 51i performs a process of mixing the two signals between the two channels selected by the switch unit 51e. Concretely, in accordance with the mixing amount, the mixing processing unit 51i performs the process of mixing the uncorrelated signal or the measurement signal (already generated signal) of one channel and the uncorrelated signal of the other. Then, the mixing processing unit 51i provides the switch unit 51j with the signal (corresponding to the measurement signal for the appropriate channel) obtained by the mixing. Thus, the mixing processing unit 51i functions as the mixing processing unit in the present invention.

The switch unit 51j obtains the measurement signal from the mixing processing unit 51i, and switches the channel of the memory unit 51k for storing the measurement signal, in accordance with a command from the control unit 16 . The memory unit 51k stores the measurement signals for the five channels, and provides the stored measurement signals to the appropriate speakers 18C, 18R, 18L, 18SR and 18SL.

In FIG. 7, such an example that the channel CH1 is treated as the basis is shown. Namely, such an example that the processing unit sequentially generates the measurement signals of the other channels CH2 to CH5 on the basis of the channel CH1 is shown. Therefore, as shown in FIG. 7, the memory unit 51k corresponding to the channel CH1 is provided with the uncorrelated signal by the memory unit 51d in the uncorrelated signal generating unit 51a, and directly stores the uncorrelated signal. Namely, as for the channel CH1, the uncorrelated signal is directly used as the measurement signal.

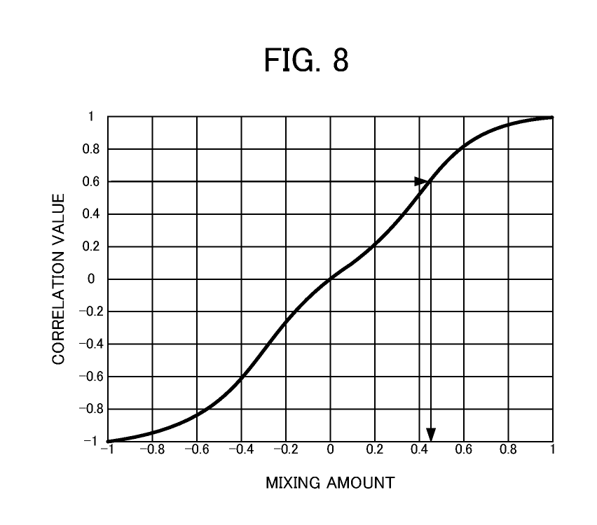

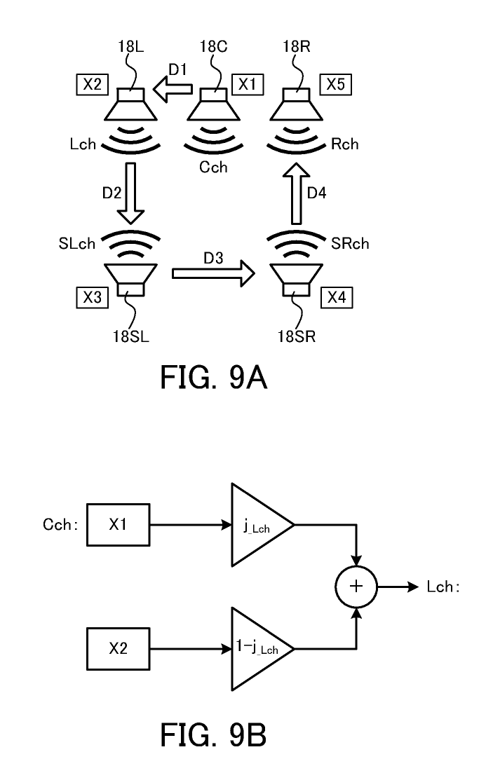

Next, a description will be given of an example of the process performed by the mixing amount determination processing unit 51h and the mixing processing unit 51i, with reference to FIG. 8 and FIGS. 9A and 9B.

FIG. 8 is a diagram for explaining a concrete example of a method for determining the mixing amount. Concretely, FIG. 8 shows an example of the relationship between the mixing amount and the correlation value. The relationship is obtained by preliminarily performing an experiment, for example. By referring to the relationship, the mixing amount determination processing unit 51h determines the mixing amount corresponding to the correlation value (correlation value information) obtained by the random number generation processing unit 51g. For example, when “0.6” is obtained as the correlation value, the mixing amount determination processing unit 51h determines “0.45” as the mixing amount (see arrows in FIG. 8).

FIGS. 9A and 9B are diagrams for explaining a concrete example of the mixing processing method. Here, such an example that the measurement signals used for the channels of each speaker are generated as shown in FIG. 9A when the five speakers 18C, 18L, 18SL, 18SR and 18R are used will be given. Concretely, in the example, on the basis of the front speaker 18C, the mixing processing unit 51i sequentially generates the measurement signals of the other speakers 18L, 18SL, 18SR and 18R in consideration of the correlation value between the adjacent two channels. In this case, the channel of the speaker 18C corresponds to the channel CH1 shown in FIG. 7. Specifically, as shown by white arrows D1, D2, D3 and D4, on the basis of the speaker 18C, the mixing processing unit 51i sequentially generates the measurement signals, in order of the channel of the speaker 18L, the channel of the speaker 18SL, the channel of the speaker 18SR, and the channel of the speaker 18R.

Additionally, as shown in FIG. 9A, the uncorrelated signals used by each channel of the speakers 18C, 18L, 18SL, 18SR and 18R are represented by “X1”, “X2”, “X3”, “X4” and “X5”, respectively. The uncorrelated signals are stored in the memory unit 51d, and are provided to the mixing processing unit 51i by being selected by the switch unit 51e. In addition, the measurement signals used by each channel of the speakers 18C, 18L, 18SL, 18SR and 18R are represented by “Cch”, “Lch”, “SLch”, “SRch” and “Rch”, respectively. Since the channel of the speaker 18C is treated as the basis, the uncorrelated siganal X1 is used as the measurement signal Cch of the channel of the speaker 18C.

FIG. 9B is a diagram for explaining a method for calculating the measurement signal Lch of the channel of the speaker 18L. In this case, as shown by the arrow D1 in FIG. 9A, the mixing processing unit 51i takes into consideration the correlation between the channel of the speaker 18C and the channel of the speaker 18L, and calculates the measurement signal Lch of the speaker 18L. Concretely, the mixing processing unit 51i calculates the measurement signal Lch, based on the uncorrelated signal X1 of the speaker 18C, the uncorrelated signal X2 of the speaker 18L and a mixing amount “j_{—Lch}” determined between the channels of the speakers 18C and 18L. In details, as shown in FIG. 9B, the mixing processing unit 51i adds a value obtained by multiplying the uncorrelated signal X1 of the speaker 18C by “j_{—Lch}” to a value obtained by multiplying the uncorrelated signal X2 of the speaker 18L by “1-j_{—Lch}”, and outputs the added value as the measurement signal Lch. Namely, the mixing processing unit 51i obtained the measurement signal Lch by calculating the following equation (1).

Lch=j_{—Lch}·X1+(1−j_{Lch})·X2 (1)

Next, as shown by the arrow D2 in FIG. 9A, the mixing processing unit 51i takes into consideration the correlation between the channel of the speaker 18L and the channel of the speaker 18SL, and calculates the measurement signal SLch of the speaker 18SL. Concretely, the mixing processing unit 51i calculates the measurement signal SLch, based on the measurement signal Lch of the speaker 18L obtained by the equation (1), the uncorrelated signal X3 of the speaker 18SL and a mixing amount “j_{—SLch}” determined between the channels of the speakers 18L and 18SL. In details, the mixing processing unit 51i obtained the measurement signal SLch by calculating the following equation (2).

SLch=j_{—SLch}·Lch+(1−j_{—SLch})·X3 (2)

Next, as shown by the arrow D3 in FIG. 9A, the mixing processing unit 51i takes into consideration the correlation between the channel of the speaker 18SL and the channel of the speaker 18SR, and calculates the measurement signal SRch of the speaker 18SR. Concretely, the mixing processing unit 51i calculates the measurement signal SRch, based on the measurement signal SLch of the speaker 18SL obtained by the equation (2), the uncorrelated signal X4 of the speaker 18SR and a mixing amount “j_{—SRch}” determined between the channels of the speakers 18SL and 18SR. In details, the mixing processing unit 51i obtained the measurement signal SRch by calculating the following equation (3).

SRch=j_{—SRch}·SLch+(1−j_{—SRch})·X4 (3)

Next, as shown by the arrow D4 in FIG. 9A, the mixing processing unit 51i takes into consideration the correlation between the channel of the speaker 18SR and the channel of the speaker 18R, and calculates the measurement signal Rch of the speaker 18R. Concretely, the mixing processing unit 51i calculates the measurement signal Rch, based on the measurement signal SRch of the speaker 18SR obtained by the equation (3), the uncorrelated signal X5 of the speaker 18R and a mixing amount “j_{—Rch}” determined between the channels of the speakers 18SR and 18R. In details, the mixing processing unit 51i obtained the measurement signal Rch by calculating the following equation (4).

Rch=j_{—Rch}·SRch+(1−j_{—Rch})·X5 (4)

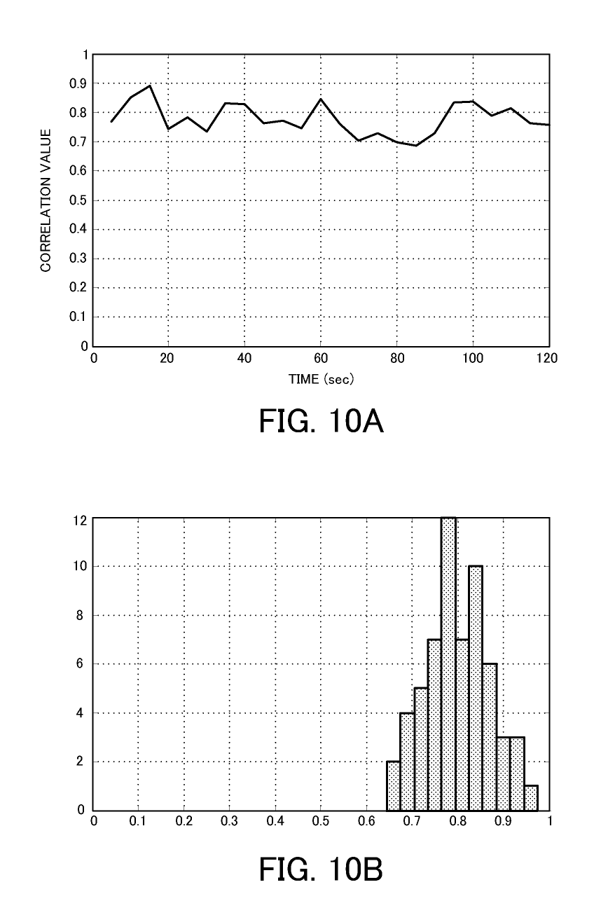

FIGS. 10A and 10B are diagrams showing examples of the correlation value of the measurement signals generated by the above manner. FIG. 10A shows the correlation value of the generated measurement signals. Concretely, FIG. 10A shows a time variation of the correlation value between the channels of the speakers 18C and 18L. Additionally, FIG. 10B shows a histogram of data used for generating the measurement signals. In FIGS. 10A and 10B, such an example that “0.7914” is used as the average value of the correlation value between the channels and “0.0637” is used as the standard deviation is shown.

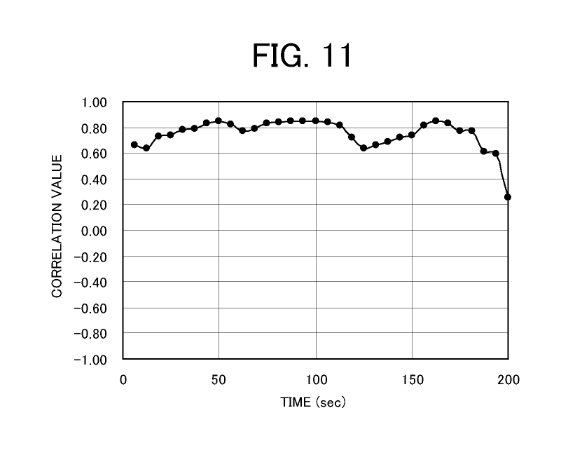

Meanwhile, FIG. 11 shows an example of the correlation value of the real content. Concretely, FIG. 11 shows a time variation example of the correlation value between the channels of the speakers 18C and 18L. If FIG. 11 is compared with FIG. 10A, it can be understood that the measurement signals generated by the method according to the embodiment can appropriately simulate the time variation of the correlation value between the channels of the real content.

The above embodiment shows such an example that the measurement signals are generated on the basis of the channel of the speaker 18C, the channel of the speaker 18L, the channel of the speaker 18SL, the channel of the speaker 18SR, and the channel of the speaker 18R, in that order (see the white arrows D1, D2, D3 and D4 in FIG. 9A). However, it is not limited that the measurement signals are generated in that order. This is an example of the method for generating the measurement signals based on the correlation between the adjacent channels. So, it is not limited that the speaker 18C is treated as the basis, and it is not limited that the measurement signals are generated in a counterclockwise direction (in order of the white arrow D1, the white arrow D2, the white arrow D3 and the white arrow D4). In other words, if the measurement signals are generated based on the correlation between the adjacent channels, the channel of the speaker other than the speaker 18C may be treated as the basis, and the measurement signals maybe generated in a clockwise direction (in reverse order of the white arrow D1, the white arrow D2, the white arrow D3 and the white arrow D4).

[Measurement Signal Generating Process]

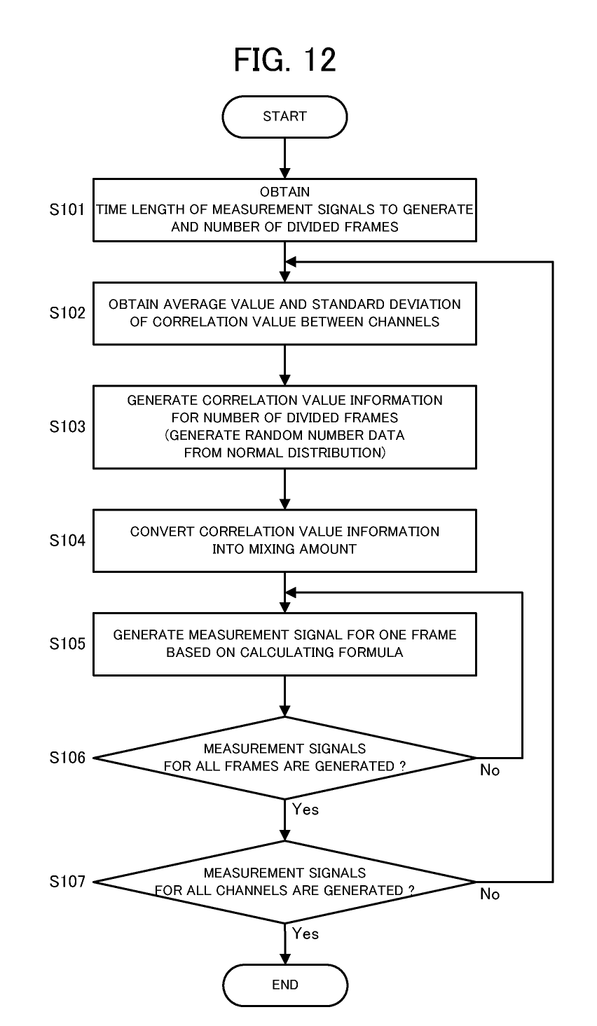

Next, a description will be given of a process (measurement signal generating process) performed by the measurement signal generating unit 51 shown in FIG. 7, with reference to FIG. 12. FIG. 12 is a flowchart showing the measurement signal generating process according to the embodiment. The process is repeatedly executed by the measurement signal generating unit 51.

First, in step S101, the measurement signal generating unit 51 obtains the time length of the measurement signals to generate and the number of the divided frames. Concretely, the measurement signal generating unit 51 obtains these from the control unit 16, and performs the setting. For example, the measurement signal generating unit 51 sets the time length of the measurement signals to “60(sec)”, and sets the number of the divided frames to “60 frames”. As an example, the control unit 16 sets the time length and the number of the divided frames in accordance with a command from the user, and provides these to the measurement signal generating unit 51. After the process in step S101 ends, the process goes to step S102.

In step S102, the measurement signal generating unit 51 obtains the average value and the standard value of the correlation value between the channels in the plural channels. Concretely, the measurement signal generating unit 51 obtains these from the control unit 16. For example, the user selects at least any one of the genre of music, the melody of music and the image of the sound field, and the control unit 16 determines the average value and the standard deviation of the correlation value in accordance with the selection and provides the average value and the standard deviation to the measurement signal generating unit 51. In this case, the control unit 16 reads the data of the average value and the standard deviation of the correlation value, which is stored for every two channels in the plural channels in association with the genre of music, the melody of music and the image of the sound field, and the control unit 16 provides the data to the measurement signal generating unit 51. After the process in step S102 ends, the process goes to step S103.

In step 103, the measurement signal generating unit 51 generates the correlation value information for the number of the divided frames. Concretely, based on the normal distribution random number generating algorithm, the correlated signal generating unit 51f in the measurement signal generating unit 51 generates the random number data (±1) for the number of the divided frames in accordance with the average value and the standard deviation of the correlation value which are obtained in step S102. Then, the process goes to step S104.

In step S104, the measurement signal generating unit 51 converts the correlation value information into the mixing amount. Concretely, based on the relationship (such as map) between the correlation value and the mixing amount which is preliminarily calculated by the experiment, the mixing amount determination processing unit 51h in the measurement signal generating unit 51 determines the mixing amount corresponding to the correlation value information generated instep S103. Then, the process goes to step S105.

In step S105, the measurement signal generating unit 51 generates the measurement signal for one frame, based on the predetermined calculating formula. Concretely, by using the above equations (1) to (4), the mixing processing unit 51i in the measurement signal generating unit 51 mixes the two signals by the mixing amount determined in step S104, so as to generate the measurement signal for one frame. In details, in accordance with the mixing amount, the mixing processing unit 51i performs the process of mixing the measurement signal (already generated signal) of one channel and the uncorrelated signal of the other. Then, the process goes to step S106.

In step S106, the measurement signal generating unit 51 determines whether or not the measurement signals for all frames (for example, 60 frames) are generated. When the measurement signals for all frames are generated (step S106; Yes), the process goes to step S107. In contrast, when the measurement signals for all frames are not generated (step S106; No), the process goes back to step S105. In this case, the measurement signal generating unit 51 performs the process of generating the measurement signal of the next frame.

In step S107, the measurement signal generating unit 51 determines whether or not the measurement signals for all channels (for example, five channels) are generated. When the measurement signals for all channels are generated (step S107 ; Yes), the process ends. In contrast, when the measurement signals for all channels are not generated (step S107; No), the process goes back to step S102. In this case, by performing the above processes in steps S102 to S106, the measurement signal generating unit 51 generates the measurement signals of the next channel.

By the above measurement signal generating process, it is possible to generate the measurement signals having the correlation between the channels which is close to the real content. Therefore, by performing the sound field correction by using the measurement signals, it becomes possible to reduce the gap with the evaluation at the time of reproducing the real content. Namely, by the process, it becomes possible to appropriately evaluate the characteristic when the plural channels are synthesized.

[Modification]

The above embodiment shows such an example that the measurement signals are generated based on the correlation between the adjacent channels (see FIGS. 9A and 9B), but the method for generating the measurement signals is not limited to the above method. Namely, instead of the correlation between the adjacent channels, the measurement signals can be generated based on the correlation between arbitrary channels (for example, based on the correlation between relatively strongly-correlated channels).

Additionally, it is not limited that the process of generating the measurement signals is performed every time the sound field measurement is performed. As an example, when the memory in the device has a sufficient capacity, the measurement signals preliminarily generated by the above method may be stored in the memory, and the sound field measurement may be performed by reading the measurement signals from the memory. As another example, the measurement signals preliminarily generated by the above method may be stored in storage media such as a CD and a DVD, and the sound field measurement may be performed by reproducing the storage media.

### INDUSTRIAL APPLICABILITY

This invention can be used for an AV system capable of generating a measurement signal used for a surround correction.

1. A measurement signal generating device which generates measurement signals for plural channels, comprising:
an original signal obtaining unit which obtains an original signal which is a basic signal for generating the measurement signal, for each of the plural channels;
a correlation value storage unit which stores an average value and a standard value of a correlation value between two channels which are preliminarily determined, for each of plural combinations of the two channels selected in the plural channels; and
a measurement signal generating unit which generates the measurement signals for the two channels by mixing the original signals of the two channels based on the average value and the standard value of the correlation value between the two channels, for each of the plural combinations to generate the measurement signals for the plural channels.

2. The measurement signal generating device according to claim 1,
wherein the correlation value storage unit stores the average value and the standard value of the correlation value between the two channels which are preliminarily determined based on a real content signal.

3. The measurement signal generating device according to claim 1,
wherein the correlation value storage unit and the measurement signal generating unit select adjacent channels as the two channels in the plural channels.

4. The measurement signal generating device according to claim 1,
wherein the measurement signal generating unit includes a random number generating unit which generates random number data of the correlation value having a variation in a time direction, in accordance with the average value and the standard deviation of the correlation value between the two channels, based on a normal distribution random number generating algorithm.

5. The measurement signal generating device according to claim 4,
wherein the measurement signal generating unit includes a mixing amount determining unit which determines the amount for mixing the two signals between the two channels, based on the random number data generated by the random number generating unit.

6. The measurement signal generating device according to claim 5,
wherein the original signal obtaining unit obtains an uncorrelated signal as the original signal, and
wherein the measurement signal generating unit includes a mixing processing unit which performs a process of mixing uncorrelated signals between arbitrary two channels in the uncorrelated signals obtained for the plural channels, or mixing the uncorrelated signal obtained for the plural channels and the measurement signal, by the mixing amount determined by the mixing amount determining unit.

7. The measurement signal generating device according to claim 1,
wherein the average value and the standard deviation of the correlation value are set based on at least either one of a genre of music and a melody of music.

8. The measurement signal generating device according to claim 1, further comprising a storage unit which stores the measurement signals generated by the measurement signal generating unit.

9. A measurement signal generating method which generates measurement signals for plural channels, comprising:
an original signal obtaining process which obtains an original signal which is a basic signal for generating the measurement signal, for each of the plural channels;
a correlation value storage process which stores an average value and a standard value of a correlation value between two channels which are preliminarily determined, for each of plural combinations of the two channels selected in the plural channels; and
a measurement signal generating process which generates the measurement signals for the two channels by mixing the original signals of the two channels based on the average value and the standard value of the correlation value between the two channels, for each of the plural combinations to generate the measurement signals for the plural channels.

10. A computer program product in a computer-readable medium executed by a measurement signal generating device comprising a computer which generates measurement signals for plural channels, making the computer function as:
an original signal obtaining unit which obtains an original signal which is basic signal for generating the measurement signal, for each of the plural channels;
a correlation value storage unit which stores an average value and a standard value of a correlation value between two channels which are preliminarily determined, for each of plural combinations of the two channels selected in the plural channels; and
a measurement signal generating unit which generates the measurement signals for the two channels by mixing the original signals of the two channels based on the average value and the standard value of the correlation value between the two channels, for each of the plural combination so as to generate the measurement signals for the plural channels.

11. A storage medium storing measurement signals for plural channels,
wherein the measurement signals for the plural channels differ in a correlation value between two channels in the plural channels.

12. The storage medium according to claim 11,
wherein the measurement signals for the plural channels are generated by a measurement signal generating device,
wherein the measurement signal generating device, comprising:
an original signal obtaining unit which obtains an original signal which is a basic signal for generating the measurement signal, for each of the plural channels;
a correlation value storage unit which stores an average value and a standard value of a correlation value between two channels which are preliminarily determined, for each of plural combinations of the two channels selected in the plural channels; and
a measurement signal generating unit which generates the measurement signals for the two channels by mixing the original signals of the two channels based on the average value and the standard value of the correlation value between the two channels, for each of the plural combinations, so as to generate the measurement signals for the plural channels.
